(19) United States
(12) Patent Application Publication
(10) Pub. No.: US 2020/0242890 A1
(43) Pub. Date: Jul. 30, 2020

(54) PACHINKO-STYLE WAGERING GAME AND RELATED DEVICES, SYSTEMS, AND METHODS

(71) Applicant: IGT, Las Vegas, NV (US)

(72) Inventor: Shara MILLER, Oakland, CA (US)

(73) Assignee: IGT

(21) Appl. No.: 16/256,930

(22) Filed: Jan. 24, 2019

(51) Int. Cl. G07F 17/32

(52) U.S. Cl. CPC G07F 17/3262; G07F 17/3244; G07F 17/3213

(57) ABSTRACT

A gaming device displays a game board having a play field, a plurality of entry locations located above the play field, a plurality of goal locations located below the play field, and a plurality of deflection pegs spaced apart in the play field between the plurality of entry locations and the plurality of goal locations. In response to a player initiating a game, a particular entry location is selected based on a player parameter value. A game token is released toward the particular entry location and movement of the game token is controlled to fall downward towards the plurality of goal locations. In response to the game token reaching a location occupied by a respective deflection peg, movement of the game token is deflected by the respective deflection peg. When game token reaches a particular goal location, a game result associated with the particular goal location is generated.

### BACKGROUND

Embodiments described herein relate to a wagering game for gaming devices, and in particular for a pachinko-style wagering game for gaming devices. Gaming devices, including electronic gaming devices such as electronic gaming machines (EGM) or mobile gaming devices, are systems that allow users to place a wager on the outcome of a random event, such as the spinning of mechanical or virtual reels or wheels, the playing of virtual cards, the rolling of mechanical or virtual dice, the random placement of tiles on a screen, etc. Manufacturers of gaming devices have incorporated a number of enhancements to the gaming devices to allow players to interact with the gaming devices in new and more engaging ways. For example, early slot machines allowed player interaction by pulling a lever or arm on the machine. As mechanical slot machines were replaced by electronic slot machines, a range of new player interface devices became available to gaming device designers and were subsequently incorporated into gaming devices. Examples of such interface devices include electronic buttons, wheels, and, more recently, touchscreens and three-dimensional display screens. However, the aspects of wagering games played on gaming devices may be perceived by players as being less enjoyable and entertaining because of the perceived lack of skill and/or variety in available game features.

### BRIEF SUMMARY

According to some embodiments, an electronic gaming device is disclosed. The electronic gaming device includes a display device, a processor circuit, and a memory coupled to the processor circuit. The memory includes machine-readable instructions that, when executed by the processor circuit, cause the processor circuit to display a game board at the display device. The game board includes a play field, a plurality of entry locations located above the play field, a plurality of goal locations located below the play field, and a plurality of deflection pegs spaced apart in the play field between the plurality of entry locations and the plurality of goal locations. The machine readable instructions further cause the processor to, in response to a player initiating a game, select a particular entry location of the plurality of entry locations based on a player parameter value associated with the player. The machine readable instructions further cause the processor to release a game token toward the particular entry location and control movement of the game token the game token to fall downward from the particular entry location towards the plurality of goal locations. In response to the game token reaching a location occupied by a respective deflection peg of the plurality of deflection pegs, movement of the game token is deflected by the respective deflection peg. The machine readable instructions further cause the processor to, in response to the game token reaching a particular goal location of the plurality of goal locations, generate a game result associated with the particular goal location.

According to some other embodiments, a computer-implemented method of providing a wagering game is disclosed. The computer-implemented method includes displaying a game board at a display device. The game board includes a play field a plurality of entry locations located above the play field, a plurality of goal locations located below the play field, and a plurality of deflection pegs spaced apart in the play field between the plurality of entry locations and the plurality of goal locations. The computer-implemented method further includes, in response to a player initiating the game, selecting, by a processing circuit, a particular entry location of the plurality of entry locations based on a player parameter value associated with the player. The computer-implemented method further includes, releasing a game token toward the particular entry location and controlling movement of the game token to fall downward from the particular entry location towards the plurality of goal locations. In response to the game token reaching a location occupied by a respective deflection peg of the plurality of deflection pegs, the game token is deflected by the respective deflection peg. The computer-implemented method further includes, in response to the game token reaching a particular goal location of the plurality of goal locations, generating a game result associated with the particular goal location.

According to some other embodiments, a gaming device is disclosed. The gaming device includes a game board having a play field, a plurality of entry locations located above the play field, a plurality of goal locations located below the play field, and a plurality of deflection pegs located in the play field between the plurality of entry locations and the plurality of goal locations. The gaming device further includes a processor circuit and a memory coupled to the processor circuit. The memory includes machine-readable instructions that, when executed by the processor circuit, cause the processor circuit to, in response to a player initiating a game, select a particular entry location of the plurality of entry locations based on a player parameter value associated with the player. The machine readable instructions further cause the processor to cause a game token to be released toward the particular entry location, wherein releasing the game token causes the game token to fall downward from the particular entry location towards the plurality of goal locations. In response to the game token contacting a respective deflection peg of the plurality of deflection pegs, the game token is deflected by the respective deflection peg. The machine readable instructions further cause the processor to, in response to the game token reaching a particular goal location of the plurality of goal locations, generating a game result associated with the particular goal location.

Other related devices and systems, and corresponding methods and computer program products according to embodiments will be or become apparent to one with skill in the art upon review of the following drawings and detailed description. It is intended that all such devices and systems, and corresponding methods and computer program products be included within this description, be within the scope of the present disclosure, and be protected by the accompanying claims. Moreover, it is intended that all embodiments disclosed herein can be implemented separately or combined in any way and/or combination.

### BRIEF DESCRIPTION OF THE DRAWINGS

FIG. 1 illustrates a gaming device having an electronic pachinko-style wagering game, according to some embodiments;

FIGS. 2A-2C illustrate elements a graphical user interface (GUI) for playing a pachinko-style wagering game similar to the pachinko-style wagering game of FIG. 1, according to some embodiments;

FIG. 3 illustrates elements a graphical user interface (GUI) for playing an alternative pachinko-style wagering game similar to the pachinko-style wagering game of FIGS. 1-2C, according to some embodiments;

FIG. 4 illustrates a gaming device having a physical pachinko-style game board for playing a pachinko-style wagering game, according to some embodiments;

FIG. 5 is a flowchart diagram of operations for providing a pachinko-style wagering game, according to some embodiments;

FIG. 6 is a schematic block diagram illustrating a system configuration for providing a pachinko-style wagering game, according to some embodiments; and

FIG. 7 is a schematic is a block diagram of components of a computing device similar to the computing devices and components of FIG. 6, according to some embodiments.

### DETAILED DESCRIPTION

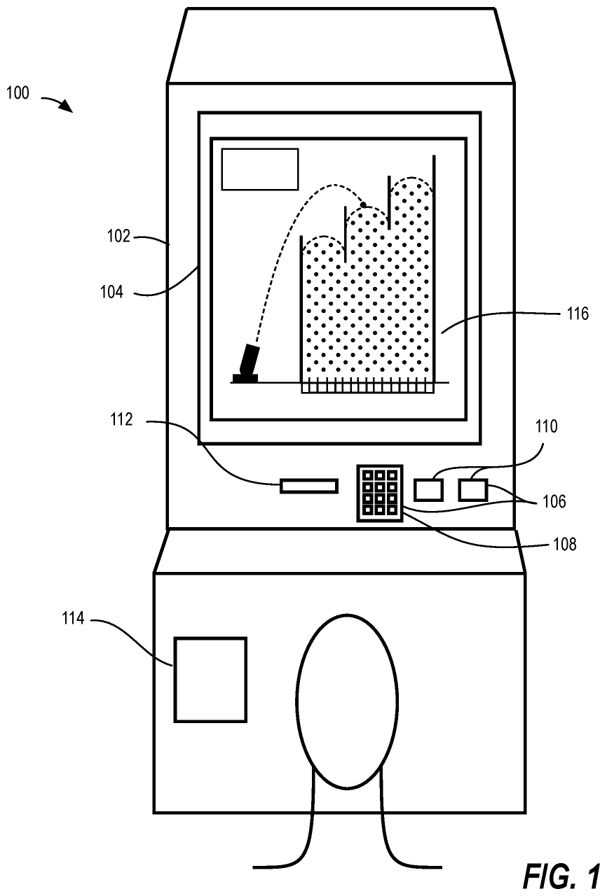

FIG. 1 illustrates a gaming device 100 having an electronic pachinko-style wagering game, according to some embodiments. The gaming device 100 includes a housing 102 having a display device 104, and a plurality of input devices 106, such as a keypad 108, buttons 110, etc., for receiving user input for playing the wagering game and otherwise interacting with the gaming device 100. In some embodiments, the display device 104 may include a touchscreen interface for receiving user input as well. The gaming device 100 may include additional specialized hardware as well, such as an acceptor 112, for receiving currency (i.e., bills and/or coins), tokens, credit or debit cards, or other physical items associated with monetary or other value. The gaming device 100 may also include a dispenser 114, for dispensing items, such as physical items having monetary or other value (e.g., awards or prizes) or other items.

As will be discussed in detail below, the gaming device 100 may include a processor circuit and a memory coupled to the processor circuit. The memory includes machine-readable instructions that, when executed by the processor circuit, cause the processor circuit to perform operations for conducting the pachinko-style wagering game. In this example, the pachinko-style wagering game is conducted using a graphical user interface (GUI) 116 displayed by the display device 104.

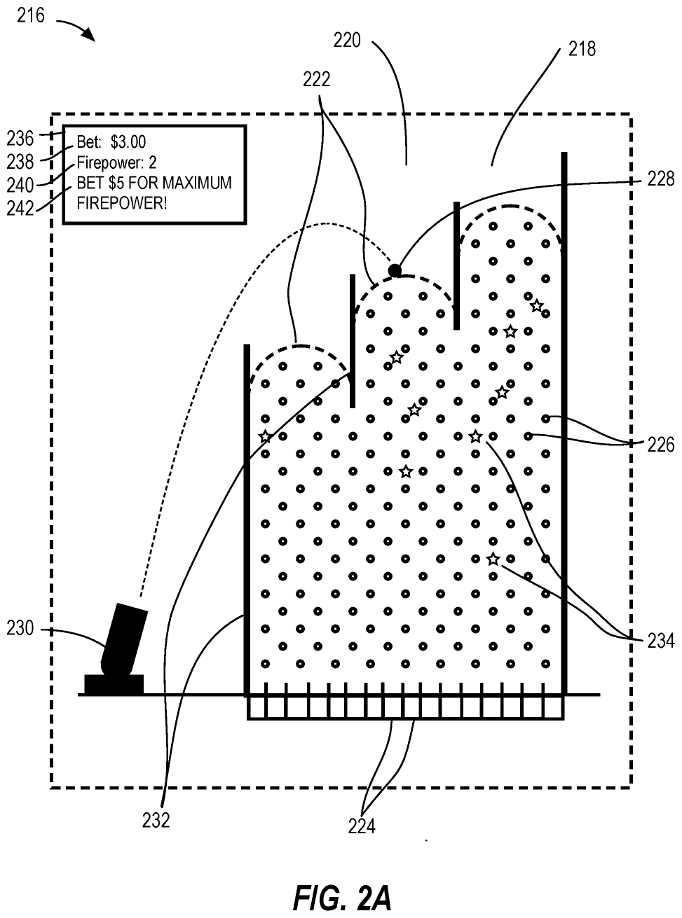

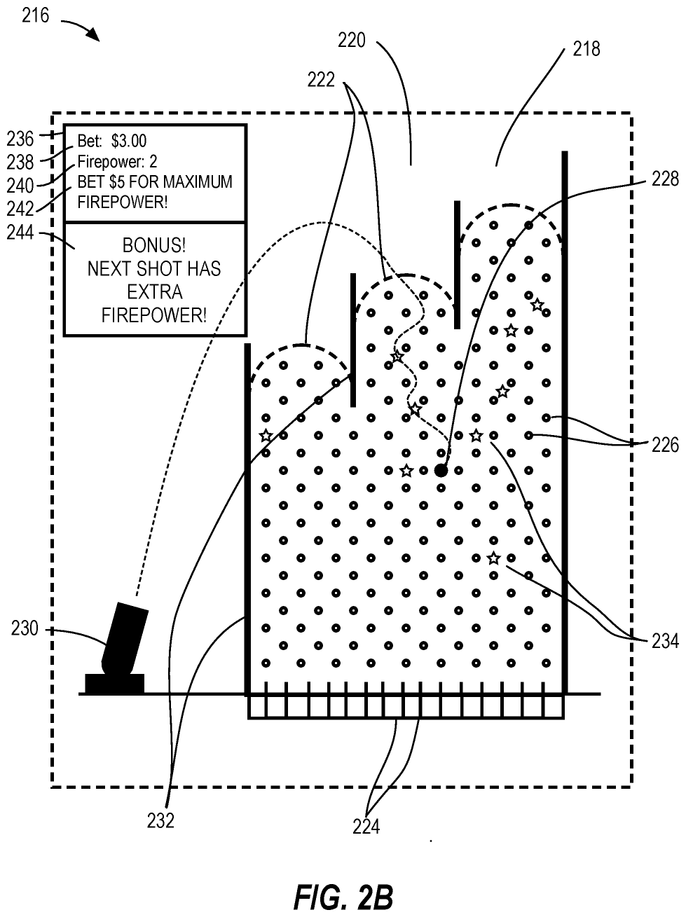

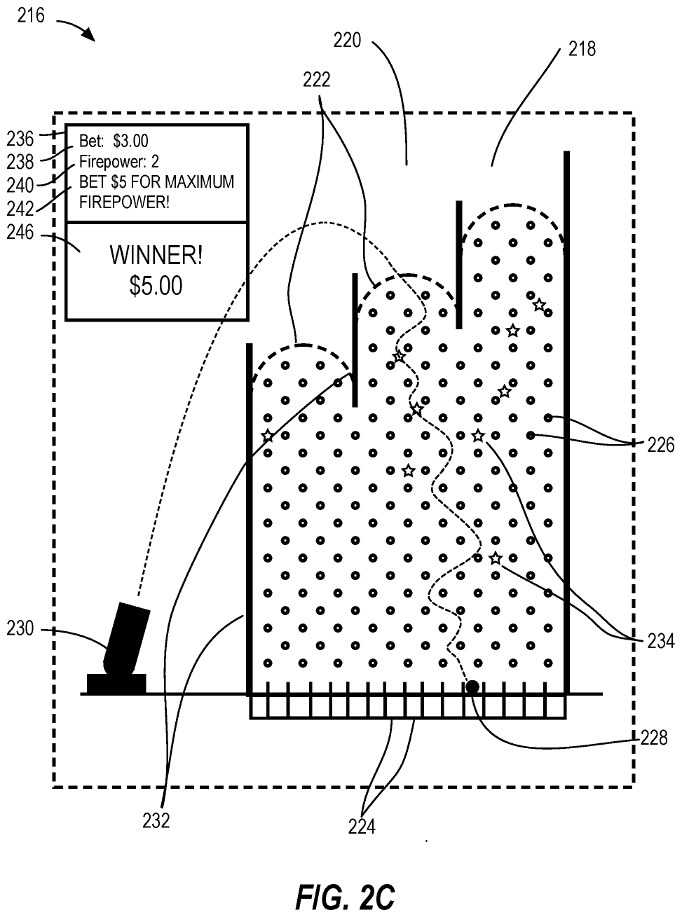

Referring now to FIGS. 2A-2C, elements a GUI 216 for playing a pachinko-style wagering game similar to the GUI 116 of FIG. 1 is illustrated, according to some embodiments. The GUI 216 is controlled in response to machine readable instructions being executed by the processor circuit. The GUI 216 displays a game board 218 having a play field 220, a plurality of entry locations 222 located above the play field 220, a plurality of goal locations 224 located below the play field 220, and a plurality of deflection pegs 226 spaced apart in the play field 220 between the plurality of entry locations 222 and the plurality of goal locations 224.

In response to a player initiating the game (such as by placing a wager, for example), a particular entry location 222 is selected based on a player parameter value associated with the player. In this embodiment, for example, a player parameter value may include a “firepower” value associated with a trajectory and distance of a game token 228 that is launched from a token launcher 230 (e.g., a simulated cannon and cannonball in this example). As shown by FIG. 2A, the game token 228 is released toward the particular entry location 222 (e.g., launched toward the center entry location in this example), and the in-game physics control movement of the game token 228 to fall downward from the particular entry location 222 towards the plurality of goal locations 224.

As shown by FIG. 2B, in response to the game token 228 reaching a location occupied by one of the deflection pegs 226, movement of the game token 228 is deflected by the respective deflection peg 226. In this example, the in-game physics simulate normal gravity, with the game token 228 continuing downwardly over time and the deflection pegs 226 acting as passive barriers, but it should be understood that other arrangements are possible. For example, in some embodiments, the game token contacting a deflection peg 226 may cause the deflection peg 226 to forcibly “bounce” the game token 228 away from the deflection peg 226, similar to a pinball bumper mechanism. In other embodiments, the in-game gravity may be variable at different locations in the play field and/or in response to in-game events, as desired. In this example, the GUI 216 may also include a plurality of walls 232, which confine and redirect the game token 228 so that the game token 228 remains within the playfield 220 as it travels between the entry location 222 toward the goal locations 224.

In this example, the play field 220 may also include a plurality of bonus locations 234 between subsets of entry locations 222 and the goal locations 224. In response to the game token 228 reaching a bonus location 234, i.e., contacting and/or passing through the bonus location 234, a bonus award associated with the bonus location 234 may be awarded to the player. In some embodiments, different bonus locations 234 may be associated with different bonus awards, and may be denoted by different indicia, such as different colors for example.

As shown by FIG. 2C, in response to the game token 228 reaching a particular goal location 224, a game result associated with the particular goal location is generated. The game result or aspects thereof associated with different goal locations 224 may be predetermined or randomly generated, and may also be displayed by the GUI 216 so that the player can aim for an entry location 222 that has a higher likelihood of reaching a particularly desirable goal location 224 or group of goal locations 224.

As shown by FIGS. 2A-2C, the GUI 216 may also include an information display 236, which may contain information that is useful to the player, such as bet information 238, game parameter information 240 (firepower in this example), and/or other information, such as a game suggestion 242. As shown by FIGS. 2B and 2C, the information display 236 may also selectively include a bonus award display 244 in response to the player winning a bonus award, and a game award display 246 in response to the game token reaching a particular goal location 224.

In some embodiments, different entry locations 222 each have a different average payout value. A particular entry location 222 may be selected in response to the player parameter value failing to satisfy a predetermined threshold condition. For example, in the example of FIGS. 2A-2C, the player parameter is a bet amount, which may be between $1.00 and $5.00. If the player wagers $5.00, which exceeds a predetermined minimum wager amount, the player has a maximum firepower of 3, which allows the game token 228 to be launched toward the rightmost entry locations 222, which are in turn have the highest average payout values. In this example, the $3.00 wager does not satisfy the maximum (3) firepower threshold, but does satisfy the medium (2) firepower threshold, which allows the game token 228 to be launched toward the middle entry locations 222, which have lower average payout values. In some examples, the player may have the option to use their firepower across multiple shots. For example, rather than applying both firepower credits in a single shot that launches the game token 228 toward the middle entry locations 222, the player may opt to fire two low (1) firepower shots, which launches the game token 228 in each shot toward the leftmost entry locations 222. In this example, the leftmost entry points 222 may have lower individual average payout values, which may add up to a total average payout value that is equal to (or different than) the average payout value for a single medium (2) firepower shot. It should be understood that other player parameter values may be used to select the particular entry location 222, including, for example, determining a player parameter value based on a player status associated with the player, wherein satisfying the predetermined threshold includes the player status exceeding a predetermined minimum player status. It should also be understood that, while some examples describe a wagering game that is initiated in response to the player places a wager, the game may be initiated in other ways that do not necessarily require a wager, such as determining a player parameter value (such as firepower) based on the player accumulating in-game objects or triggering symbols for example.

Different entry locations 222 may also have different volatility values, as well. For example, the rightmost entry locations 222 of FIGS. 2A-2C have the highest average payouts, but also have the highest volatility, due to the higher height of the entry location 222 with respect to the goal locations 224. Because of the higher height of the rightmost entry locations 222, the game token 228 will have more interactions with deflection pegs 226, which in turn, increase the number of goal locations 224 that the game token 228 is likely to reach, and decreases the likelihood of the game token 228 reaching any one particular goal location 224.

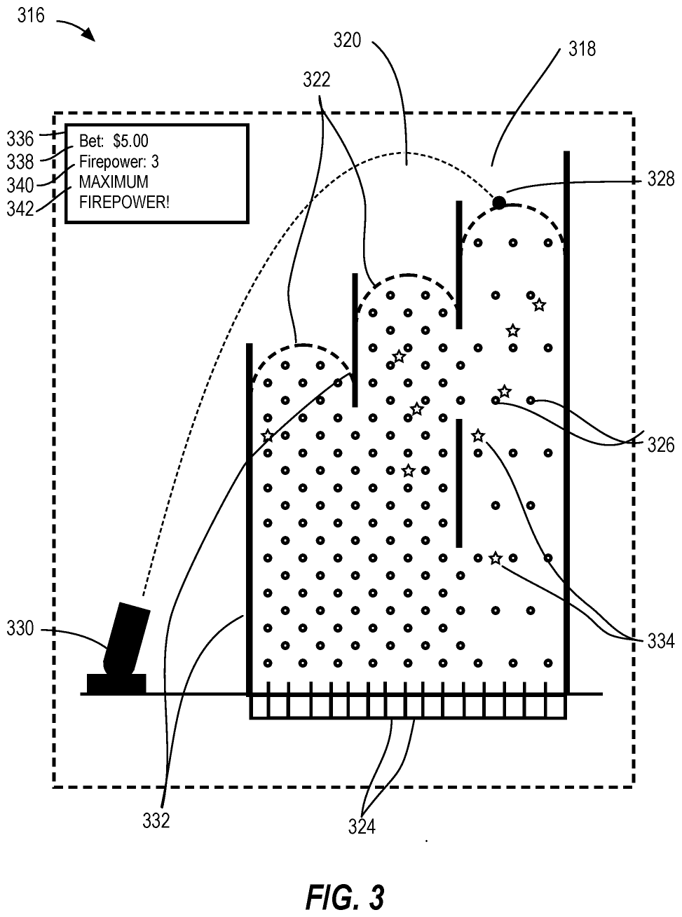

Referring now to FIG. 3, elements of a GUI 316 for playing an alternative pachinko-style wagering game similar to the GUI 216 of FIGS. 2A-2C, according to some embodiments. The GUI 316 includes a game board 318 having a play field 320, a plurality of entry locations 322 and goal locations 324, and a plurality of deflection pegs 326. The GUI 316 may also include walls 332 and bonus locations 334, as desired. In this example, the different areas of the play field have different densities of deflection pegs 326, which may affect volatility for different entry locations 322. In this embodiment, for example, the deflection pegs 326 below the rightmost entry locations 322 have a lower density than the deflection pegs 326 below the middle and leftmost entry locations 322. This may result in lower volatility and more predictability for the rightmost entry locations 322, which may incentivize the player to wager the maximum $5.00 amount to gain access to higher firepower, which allows the token launcher 330 to launch the game token 328 toward a more desirable entry location 322. The GUI 316 may also include an information display 336, which may contain information that is useful to the player, such as bet information 338, game parameter information 340, and/or other information, such as a game suggestion 342.

It should be understood that many different arrangements are contemplated. For example, the player's choice of entry location may be affected by the amount of credits available to the player or that the player is willing to spend. In this embodiment, a player may be able to spend more credits to be able to select a more attractive starting position. In some embodiments, the goal location with the highest prize value may be located at a far end of the collection area, and the entry location most directly vertically aligned with that goal location is located at the greatest height from the goal location. In other examples, the goal location with the highest prize may be placed at or near the center of the goal locations.

Advantages of these and other embodiments include adding a skill-based and/or perceived skill-based element to game play, and adding additional variety in available game features. These and other features provide a technical solution to problems associated with conventional wagering games, including the uniquely challenging technical problem of introducing skill-based elements into wagering games while maintaining an edge for the operator of the game so that the game remains reliable, predictable, and profitable over time.

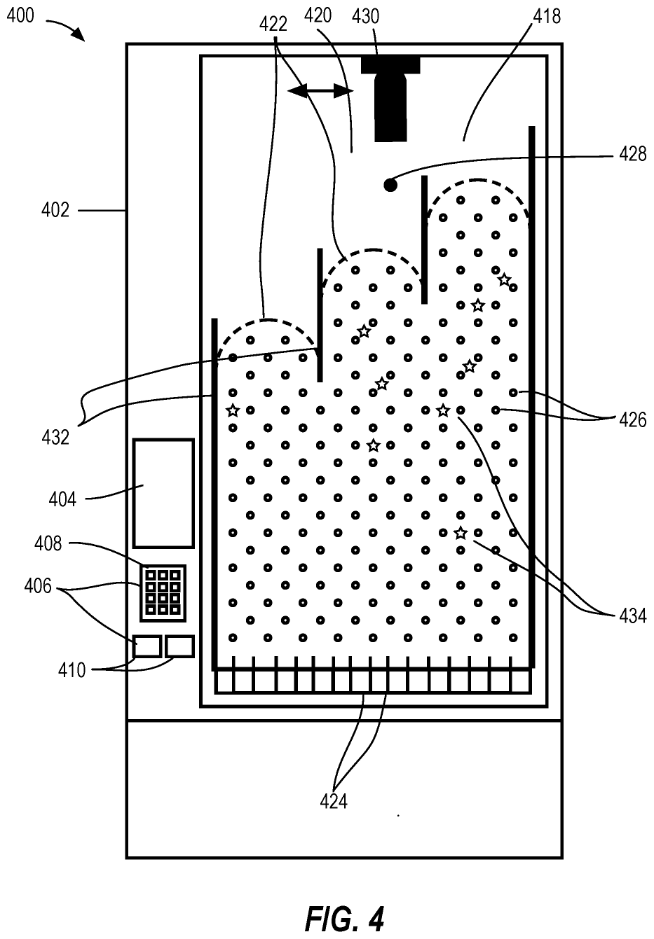

While the above embodiments describe an electronic gaming device, it should be understood that other types of gaming devices may incorporated these and other features. In this regard, referring now to FIG. 4, an alternative embodiment may include a gaming device 400 that incorporates a physical pachinko-style game board 418 for playing a pachinko-style wagering game. The gaming device 400 includes a housing 402 that includes the game board 418, and may also include a display device 404, a plurality of input devices 406, such as a keypad 408, buttons 410, etc., an acceptor 412, and/or a dispenser 414, as desired.

The physical game board 418 includes a physical play field 420, a plurality of entry locations 422 located above the physical play field 420, a plurality of goal locations 424 located below the physical play field 420, a plurality of physical deflection pegs 426 located in the physical play field 420 between the plurality of entry locations 422 and the plurality of goal locations 424. In this embodiment, the physical play field 420 may also include a plurality of physical walls 432 and bonus locations 434.

In response to a player placing a wager, a particular entry location 422 is selected based on a player parameter value associated with the player. In this embodiment, for example, a physical token launcher 430 may be selectively moved to a particular entry location 422 and may selectively release the game token 428 above the particular entry location 422 so that the game token 428 falls downward from the particular entry location 422 towards the plurality of goal locations 424. As the physical game token 428 contacts the deflection pegs 426, the game token 428 is deflected by the respective deflection peg 426.

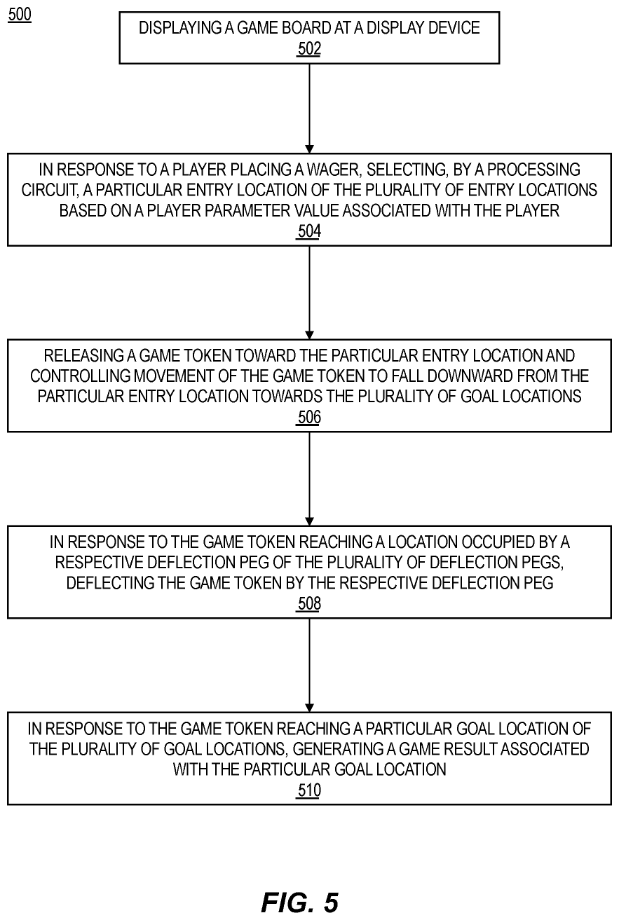

FIG. 5 is a flowchart diagram of operations for providing a pachinko-style wagering game, according to some embodiments. The operations 500 include displaying a game board at a display device (Block 502). As discussed above, the game board may include a play field, a plurality of entry locations located above the play field, a plurality of goal locations located below the play field, and a plurality of deflection pegs spaced apart in the play field between the plurality of entry locations and the plurality of goal locations. The operations 500 further include, in response to a player placing a wager, selecting, by a processing circuit, a particular entry location of the plurality of entry locations based on a player parameter value associated with the player (Block 504). The operations 500 further include releasing a game token toward the particular entry location and controlling movement of the game token to fall downward from the particular entry location towards the plurality of goal locations (Block 506). The operations 500 further include, in response to the game token reaching a location occupied by a respective deflection peg of the plurality of deflection pegs, deflecting the game token by the respective deflection peg (Block 508). The operations 500 further include, in response to the game token reaching a particular goal location of the plurality of goal locations, generating a game result associated with the particular goal location (Block 510).

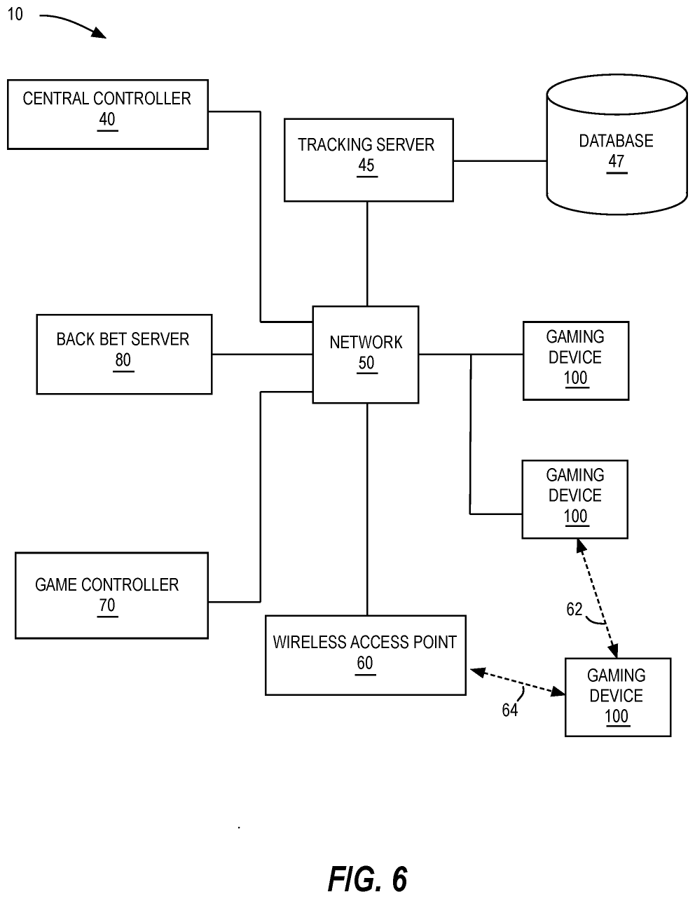

Referring now to FIG. 6, embodiments may include a system 10 having a plurality of gaming devices 100 (see FIG. 1) and/or similar devices. According to the schematic block diagram of FIG. 6, the gaming system 10 may be located, for example, on the premises of a gaming establishment, such as a casino. The gaming devices 100, which may be situated on a casino floor, may be in communication with each other and/or at least one central controller 40 through a data communication network 50 or other type of network or remote communication link. The gaming devices 100 may include, for example, electronic gaming devices such as electronic gaming machines (EGMs) or mobile devices, electromechanical gaming devices, or other devices.

The data communication network 50 may be a private data communication network that is operated, for example, by the gaming facility that operates the gaming device 100. Communications over the data communication network 50 may be encrypted for security. The central controller 40 may be any suitable server or computing device which includes at least one processor circuit, which may include a processor, and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 6, or may be connected directly to the central controller 40 or another server connected to the data communication network 50. For example, for a gaming device 100 that is a mobile gaming device, the gaming device 100 may provide game play features via an onboard processor circuit and memory via a built-in display, and may communicate with the central controller 40 and other components of the system 10 to track wagering, wins and losses based on the game result. In other embodiments, the mobile gaming device or other gaming device may be a “thin-client” that displays the game elements to the player and registers player input, while the central controller 40 performs the operations of providing and resolving the game.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 6, the gaming devices 100 of the system 10 provide primary games and/or secondary games to users of the gaming devices 100. Each gaming device 100 may include standalone game content, and may also communicate with one or more elements of the system 10 to provide game content to a player of the gaming devices 100.

For example, in some embodiments, the gaming device 100 may communicate with other components of the system 10 over a wireless interface 62, which may be a WiFi (e.g., IEEE 802.11x) link, a Bluetooth (e.g., IEEE 802.15.x) link, a near field communication (NFC) (e.g., ISO/IEC 18000-3) link, etc. In other embodiments, the gaming device 100 may communicate with the data communication network 50 (and devices connected thereto, including gaming devices) over a wireless interface 64 with the wireless access point 60. The wireless interface 64 may include a WiFi link, a Bluetooth link, an NFC link, etc. In still further embodiments, the gaming device 100 may communicate simultaneously with other components of the system 10 over the wireless interface 62 and the wireless access point 60 over the wireless interface 64. In these embodiments, the wireless interface 62 and the wireless interface 64 may use different communication protocols and/or different communication resources, such as different frequencies, time slots, spreading codes, etc. For example, in some embodiments, the wireless interface 62 may be a Bluetooth link, while the wireless interface 64 may be a WiFi link.

In some embodiments, the gaming system 10 includes a game controller 70. The game controller 70 may be a computing system that communicates through the data communication network 50 with the gaming devices 100 to coordinate the provision of primary game content and/or secondary game content to one or more players using the gaming devices 100. For example, the game controller 70 may manage an electronic table game having a common dealer and/or game elements that affect multiple players of the game, such as a common dealer hand in blackjack, or a roulette spin result. The game controller 70 may be implemented within or separately from the central controller 40.

In some embodiments, the game controller 70 may coordinate the generation and display of elements of the same primary game and/or secondary game to more than one player by more than one gaming device 100. As described in more detail below, this may enable multiple players to interact with elements within the game and/or with each other in real time. This feature can be used to provide a shared multiplayer experience to multiple players at the same time. Moreover, in some embodiments, the game controller 70 may coordinate the generation and display of the same game elements to players at different gaming devices 100 at a common physical location, e.g., in a common bank of gaming devices 100, or at different physical locations, e.g., at different locations within a casino or at different locations at different casinos or other gaming establishments.

In some embodiments, at least some processing of game content, including images and/or objects that are provided by the gaming devices 100, may be performed by the game controller 70, thereby offloading at least some processing requirements from the gaming devices 100.

A back bet server 80 may be provided to manage back bets placed using a gaming device 100 as described in more detail below. A gaming device 100 may communicate with the back bet server 80 through the wireless interface 64 and network 50, for example.

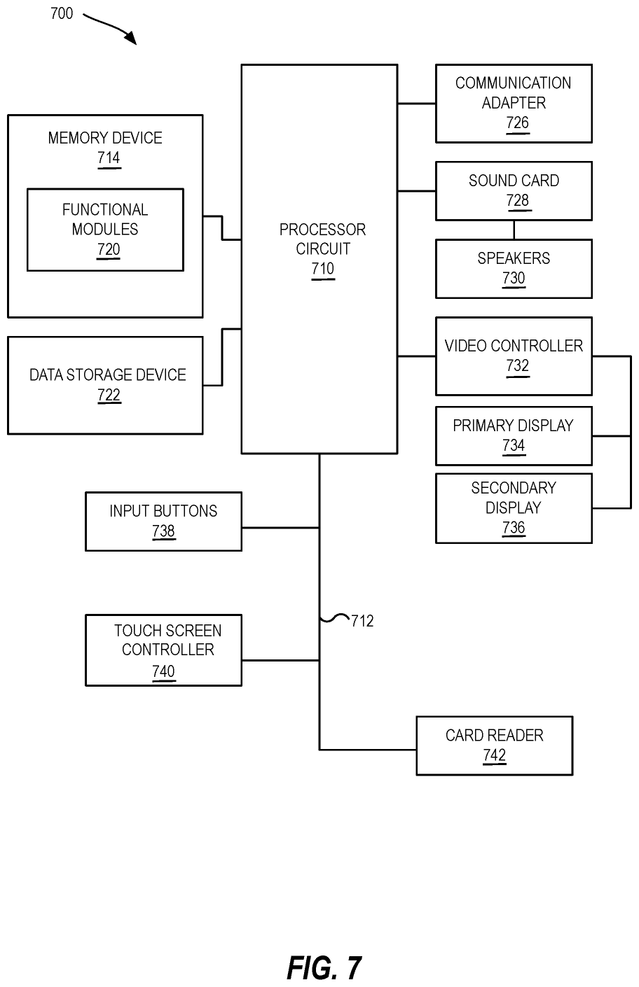

Referring now to FIG. 7, a block diagram of components of a computing device 700 similar to the computing devices and components of FIG. 6 is illustrated, according to some embodiments. The computing device 700 of FIG. 4 and/or components thereof may be suitable for use as or in connection with various components of the devices, systems and methods described herein. As shown in FIG. 7, the computing device 700 may include a processor circuit 710, or processor circuit, that controls operations of the computing device 700. Although illustrated as a single processor circuit, multiple special purpose and/or general purpose processor circuits and/or processor circuit cores may be provided in the computing device 700. For example, the computing device 700 may include one or more of a video processor circuit, a signal processor circuit, a sound processor circuit and/or a communication controller that performs one or more control functions within the computing device 700 . The processor circuit 710 may include and/or may be included in various components, which may be variously referred to as a “controller,” “microcontroller,” “microprocessor” or simply a “computer,” for example. The processor circuit may further include one or more application-specific integrated circuits (ASICs).

Various components of the computing device 700 are illustrated in FIG. 7 as being connected to the processor circuit 710. It will be appreciated that the components may be connected to the processor circuit 710 through a system bus 712, a communication bus and controller, such as a USB controller and USB bus, a network interface, or any other suitable type of connection.

The computing device 700 further includes a memory device 714 that stores one or more functional modules 720 for performing the operations described above. The memory device 714 may store machine readable instructions, such as program code for example, executable by the processor circuit 710, to control the computing device 700 . The memory device 714 may include random access memory (RAM), which can include non-volatile RAM (NVRAM), magnetic RAM (ARAM), ferroelectric RAM (FeRAM) and other forms as commonly understood in the gaming industry. In some embodiments, the memory device 714 may include read only memory (ROM). In some embodiments, the memory device 714 may include flash memory and/or EEPROM (electrically erasable programmable read only memory). Any other suitable magnetic, optical and/or semiconductor memory may operate in conjunction with the gaming device disclosed herein.

The computing device 700 may further include a data storage device 722, such as a hard disk drive or flash memory. The data storage device 722 may store program data, player data, audit trail data or any other type of data. The data storage device 722 may include a detachable or removable memory device, including, but not limited to, a suitable cartridge, disk, CD ROM, DVD or USB memory device.

The computing device 700 may include a communication adapter 726 that enables the computing device 700 to communicate with remote devices over a wired and/or wireless communication network, such as a local area network (LAN), wide area network (WAN), cellular communication network, or other data communication network. The communication adapter 726 may further include circuitry for supporting short range wireless communication protocols, such as Bluetooth and/or near field communications (NFC) that enable the computing device 700 to communicate, for example, with a mobile communication device operated by a player.

The computing device 700 may include one or more internal or external communication ports that enable the processor circuit 710 to communicate with and to operate with internal or external peripheral devices, such as a sound card 728 connected to speakers 730, a video controller 732 connected to a primary display 734 and/or a secondary display 736, input buttons 738, a touch screen controller 740, or a card reader 742, for example. Additional internal or external peripheral devices that may be used include eye tracking devices, position tracking devices, cameras, accelerometers, arcade sticks, bar code readers, bill validators, biometric input devices, button panels, card readers, currency acceptors and dispensers, mobile payment devices (e.g., NFC interfaces), additional displays or video sources, expansion buses, information panels, keypads, lights, mass storage devices, microphones, motion sensors, motors, printers, reels, SCSI ports, solenoids, speakers, thumb drives, ticket readers, trackballs, touchpads, wheels, and wireless communication devices. In some embodiments, internal or external peripheral devices may communicate with the processor circuit through a universal serial bus (USB) hub (not shown) connected to the processor circuit 710.

The computing device 700 may include 3D display device, which may be part of the primary display 734, secondary display 736, or another display. In some embodiments, displaying the game board may include displaying a play field of a pachinko-style game, such as the play field 220 of FIGS. 2A-2C for example, in a reference plane, and displaying deflection pegs, such as the deflection pegs 226 of FIGS. 2A-2C for example in a way that simulates the deflection pegs extending away from the reference plane. For example, the 3D display device may be a stereoscopic display device, wherein displaying the deflection pegs to simulate the deflection pegs extending away from the reference plane includes displaying a first image of the game board from a first perspective of a first eye of a user, and displaying a second image of the game board from a second perspective of a second eye of the user. In some embodiments, the primary display 734, the secondary display 736, and/or another display device may include a head-wearable display frame that, in response to being worn by the player, positions the 3D display device in a field of view of the player. In this embodiment, displaying the game board, such as the game board 218 of FIG. 2, may further include determining a position and orientation of the head-wearable display frame, determining a perspective of a user with respect to the game board based on the position and orientation of the head-wearable display frame, and display the game board based on the perspective of the user.

The present disclosure contemplates a variety of different systems and/or devices, each having one or more of a plurality of different features, attributes, or characteristics. In certain such embodiments, computerized instructions for controlling any features or content displayed by the display devices or other devices are executed by the central server, central controller, or remote host. In such “thin client” embodiments, the central server, central controller, or remote host remotely controls any games (or other suitable interfaces) displayed by the device, and the device is utilized to display such features (or other suitable interfaces) and to receive one or more inputs or commands. In other such embodiments, computerized instructions for controlling any features displayed by the device are communicated from the central server, central controller, and/or remote host to the device and are stored in at least one memory device of the device. In such “thick client” embodiments, the processor circuit of the device executes the computerized instructions to control any games (or other suitable interfaces) displayed by the device.

In some embodiments in which the system may include: (a) a device configured to communicate with a central server, central controller, or remote host through a data network; and/or (b) a plurality of devices configured to communicate with one another through a data network, the data network is an internet or an intranet. In these and other embodiments, an internet browser of the device is usable to access an internet game page from any location where an internet connection is available. In one such embodiment, after the internet content page is accessed, the central server, central controller, or remote host identifies a user prior to enabling that user to use particular features. In one example, the central server, central controller, or remote host identifies the user by determining that the user is logged into a user account via an input of a unique username and password combination assigned to the user. It should be appreciated, however, that the central server, central controller, and/or remote host may identify the user in any other suitable manner, such as by validating a user tracking identification number associated with the user; by reading a user tracking card or other smart card inserted into a card reader (as described below); by validating a unique user identification number associated with the user by the central server, central controller, and/or remote host; or by identifying the device, such as by identifying the MAC address or the IP address of the internet facilitator. In various embodiments, once the central server, central controller, and/or remote host identifies the user, the central server, central controller, and/or remote host enables features and/or content, and displays the features and/or content via the internet browser of the gaming device.

It should be appreciated that the central server, central controller, and/or remote host and the device(s) are configured to connect to the data network or remote communications link in any suitable manner. In various embodiments, such a connection may be accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of devices from an ever-increasing quantity of remote sites. It should also be appreciated that the enhanced bandwidth of digital wireless communications may render such technology suitable for some or all communications, such as encrypted communications, for example. Higher data transmission speeds may be useful for enhancing the sophistication and response of the display and interaction with users.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more machine readable media having machine readable instructions, such as computer readable media having computer readable program code for example, embodied thereon.

Any combination of one or more machine readable media may be utilized. The machine readable media may be a machine readable signal medium or a machine readable storage medium. A machine readable storage medium may be, for example, but not limited to, an electronic, magnetic, optical, electromagnetic, or semiconductor system, apparatus, or device, or any suitable combination of the foregoing. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a machine readable storage medium may be any medium that can contain, or store a program for use by or in connection with an instruction execution system, apparatus, or device.

A machine readable signal medium may include a propagated data signal with machine readable instructions embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device. Instructions embodied on a machine readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Haxe, Java, Scala, Smalltalk, Eiffel, JADE, Emerald, C++, C#, VB.NET, Python or the like, conventional procedural programming languages, such as JavaScript, the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor circuit of a general purpose computer, special purpose computer, or other programmable data processing apparatus to produce a machine, such that the instructions, which execute via the processor circuit of the computer or other programmable instruction execution apparatus, create a mechanism for implementing the functions/acts specified in the flowchart and/or block diagram block or blocks.

These computer program instructions may also be stored in a machine readable medium that when executed can direct a computer, other programmable data processing apparatus, or other devices to function in a particular manner, such that the instructions when stored in the machine readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well and may be interpreted as “one or more”, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. An electronic gaming device comprising:
a display device;
a processor circuit; and
a memory coupled to the processor circuit, the memory comprising machine-readable instructions that, when executed by the processor circuit, cause the processor circuit to:
display a game board at the display device, the game board comprising:
a play field;
a plurality of entry locations located above the play field;
a plurality of goal locations located below the play field; and
a plurality of deflection pegs spaced apart in the play field between the plurality of entry locations and the plurality of goal locations;
in response to a player initiating a game, select a particular entry location of the plurality of entry locations based on a player parameter value associated with the player;
release a game token toward the particular entry location and control movement of the game token to fall downward from the particular entry location towards the plurality of goal locations, and wherein, in response to the game token reaching a location occupied by a respective deflection peg of the plurality of deflection pegs, movement of the game token is deflected by the respective deflection peg; and
in response to the game token reaching a particular goal location of the plurality of goal locations, generate a game result associated with the particular goal location.

2. The electronic gaming device of claim 1, wherein the plurality of entry locations comprises: a first entry location comprising a first average payout value and a second entry location comprising a second average payout value different than the first average payout value,
wherein the machine-readable instructions further cause the processor circuit to:
in response to the player parameter value failing to satisfy a predetermined threshold condition, select the first entry location to be the particular entry location: and
in response to the player parameter value satisfying the predetermined threshold condition, select the second entry location to be the particular entry location.

3. The electronic gaming device of claim 2, wherein the player parameter value comprises an amount of a wager placed by the player to initiate the game, and wherein satisfying the predetermined threshold comprises the amount of the wager exceeding a predetermined minimum wager amount.

4. The electronic gaming device of claim 2, wherein the machine-readable instructions further cause the processor circuit to determine a player status associated with the player to determine the player parameter value based on the player status, and wherein satisfying the predetermined threshold comprises the player status exceeding a predetermined minimum player status.

5. The electronic gaming device of claim 1, wherein a first entry location of the plurality of entry locations comprises a first volatility value corresponding to a first height of the first entry location with respect to the plurality of goal locations,
wherein a second entry location of the plurality of entry locations comprises a second volatility value corresponding to a second height of the second entry location with respect to the plurality of goal locations, wherein the first volatility value is different than the second volatility value and the first height is different than the second height.

6. The electronic gaming device of claim 5, wherein the first entry location comprises a first average payout value,
wherein the second entry location of the plurality of entry locations comprises a second average payout value higher than the first average payout value,
wherein the machine-readable instructions further cause the processor circuit to select one of the first entry location and the second entry location further based on whether the player parameter value satisfies a predetermined threshold condition.

7. The electronic gaming device of claim 1, wherein the game board further comprises a bonus location between a subset of the plurality of entry locations and the plurality of goal locations, and
wherein, in response to the game token reaching the bonus location, the machine-readable instructions further cause the processor circuit to award a bonus award associated with the bonus location to the player.

8. The electronic gaming device of claim 1, wherein the display device comprises a 3D display device, and
wherein displaying the game board comprises displaying the play field in a reference plane, and displaying the deflection pegs to simulate the deflection pegs extending away from the reference plane.

9. The electronic gaming device of claim 8, wherein the 3D display device is a stereoscopic display device, and
wherein displaying the deflection pegs to simulate the deflection pegs extending away from the reference plane comprises:
displaying a first image of the game board from a first perspective of a first eye of a user, and
displaying a second image of the game board from a second perspective of a second eye of the user.

10. The electronic gaming device of claim 8, wherein the display device comprises a head-wearable display frame that, in response to being worn by the player, positions the 3D display device in a field of view of the player, and
wherein displaying the game board further comprises:
determining a position and orientation of the head-wearable display frame;
determining a perspective of a user with respect to the game board based on the position and orientation of the head-wearable display frame; and
displaying the game board based on the perspective of the user.

11. The electronic gaming device of claim 1, wherein the machine-readable instructions further cause the processor to:
select the particular entry location further in response to the player selecting one of a plurality of game options,
wherein, in response to the player selecting a first option of the plurality of options, a first entry location is selected as the particular entry location, a first number of tokens are released toward a first entry locations, and in response to the game tokens reaching respective particular goal locations, generate the game result based on the game results associated with the respective particular goal locations, and
wherein, in response to the player selecting a second option of the plurality of options, a second entry location is selected as the particular entry location, a second number of tokens are released toward the second entry locations, and in response to the game tokens reaching respective particular goal locations, generate the game result based on the game results associated with the respective particular goal locations.

12. A computer-implemented method of providing a wagering game comprising:
displaying a game board at a display device, the game board comprising:
a play field;
a plurality of entry locations located above the play field;
a plurality of goal locations located below the play field; and
a plurality of deflection pegs spaced apart in the play field between the plurality of entry locations and the plurality of goal locations;
in response to a player initiating the game, selecting, by a processing circuit, a particular entry location of the plurality of entry locations based on a player parameter value associated with the player;
releasing a game token toward the particular entry location and controlling movement of the game token to fall downward from the particular entry location towards the plurality of goal locations, and wherein, in response to the game token reaching a location occupied by a respective deflection peg of the plurality of deflection pegs, the game token is deflected by the respective deflection peg; and
in response to the game token reaching a particular goal location of the plurality of goal locations, generating a game result associated with the particular goal location.

13. The computer-implemented method of claim 12, wherein the plurality of entry locations comprises: a first entry location comprising a first average payout value and a second entry location comprising a second average payout value higher than the first average payout value, and
wherein selecting the particular entry location based on the player parameter value further comprises:
in response to the player parameter value failing to satisfy a predetermined threshold condition, selecting the first entry location to be the particular entry location: and
in response to the player parameter value satisfying the predetermined threshold condition, selecting the second entry location to be the particular entry location.

14. The computer-implemented method of claim 13, wherein the player parameter value comprises an amount of a wager placed by the player to initiate the game, and wherein satisfying the predetermined threshold comprises the amount of the wager exceeding a predetermined minimum wager amount.

15. The computer-implemented method of claim 13, further comprising determining a player status associated with the player to determine the player parameter value based on the player status, and wherein satisfying the predetermined threshold comprises the player status exceeding a predetermined minimum player status.

16. The computer-implemented method of claim 12, wherein a first entry location of the plurality of entry locations comprises a first volatility value corresponding to a first height of the first entry location with respect to the plurality of goal locations, and
wherein a second entry location of the plurality of entry locations comprises a second volatility value corresponding to a second height of the second entry location with respect to the plurality of goal locations, wherein the first volatility value is different than the second volatility value and the first height is different than the second height.

17. The computer-implemented method of claim 16, wherein the first entry location comprises a first average payout value,
wherein the second entry location of the plurality of entry locations comprises a second average payout value higher than the first average payout value,
wherein selecting the particular entry location based on the player parameter value further comprises selecting one of the first entry location and the second entry location further based on whether the player parameter value satisfies a predetermined threshold condition.

18. A gaming device comprising:
a game board comprising:
a play field;
a plurality of entry locations located above the play field;
a plurality of goal locations located below the play field; and
a plurality of deflection pegs located in the play field between the plurality of entry locations and the plurality of goal locations;
a processor circuit; and
a memory coupled to the processor circuit, the memory comprising machine-readable instructions that, when executed by the processor circuit, cause the processor circuit to:
in response to a player initiating a game, select a particular entry location of the plurality of entry locations based on a player parameter value associated with the player;
cause a game token to be released toward the particular entry location, wherein releasing the game token causes the game token to fall downward from the particular entry location towards the plurality of goal locations, and wherein, in response to the game token contacting a respective deflection peg of the plurality of deflection pegs, the game token is deflected by the respective deflection peg; and
in response to the game token reaching a particular goal location of the plurality of goal locations, generating a game result associated with the particular goal location.

19. The gaming device of claim 18, wherein the plurality of entry locations comprises: a first entry location comprising a first average payout value and a second entry location comprising a second average payout value higher than the first average payout value,
wherein the machine-readable instructions further cause the processor circuit to:
in response to the player parameter value failing to satisfy a predetermined threshold condition, select the first entry location to be the particular entry location: and
in response to the player parameter value satisfying the predetermined threshold condition, select the second entry location to be the particular entry location.

20. The gaming device of claim 19, wherein the machine-readable instructions further cause the processor circuit to determine a player status associated with the player to determine the player parameter value based on the player status, and wherein satisfying the predetermined threshold comprises the player status exceeding a predetermined minimum player status.
